(19) United States
(12) Patent Application Publication
(10) Pub. No.: US 2007/0186232 A1
(43) Pub. Date: Aug. 9, 2007

(54) Method for Utilizing a Media Adapter for Controlling a Display Device to Display Information of Multimedia Data Corresponding to a User Access Information

(76) Inventors: Shu-Yi Chen, Taipei City (TW); Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/552,512

(22) Filed: Oct. 24, 2006

(30) Foreign Application Priority Data
Feb. 9, 2006 (TW) 095104400

(51) Int. Cl. H04N 7/16

(52) U.S. Cl. 725/25

(57) ABSTRACT

A method includes inputting a user access information to a media adapter; a plurality of multimedia sources transmits category information of the multimedia data stored in the plurality of multimedia sources to the media adapter; the media adapter classifies the multimedia data transmitted from the plurality of multimedia sources according to the category information of the multimedia data received; the media adapter compares a classification result with the user access information; the media adapter outputs the comparison result to the display device; and lastly the display device displays a frame corresponding to the comparison result. The method assists parents in restricting and filtering the multimedia data that is considered unsuitable for young children or teenagers.

### BACKGROUND OF THE INVENTION

1. Field of the Invention

The present invention relates to a method for utilizing a media adapter for controlling a display device to display information of a multimedia data corresponding to a user access information, and more particularly, to a method for utilizing the media adapter for receiving category information of the multimedia data transmitted from a plurality of multimedia sources, and the media adapter classifies the multimedia data transmitted from the plurality of multimedia sources according to the category information of the multimedia data received by the media adapter from the plurality of multimedia sources, the media adapter controls the display device to display a data list of the multimedia data stored in the plurality of multimedia sources according to a classification result and a comparison result of the user access information received by the media adapter.

2. Description of the Prior Art

A characteristic of a media adapter is its ability to convert movies and image files such as media program, audio file, movie and pictures that are stored on computers, hard disks, or media servers in a wireless manner for a user to watch and listen to using traditional or digital televisions and sound systems.

Please refer to FIG. 1. FIG. 1 illustrates a diagram of a conventional media adapter 10 converting multimedia data of a plurality of multimedia sources 12 to a display device 14. The multimedia source 12 can be a computer, a hard disk, or a media server. The multimedia data stored in the multimedia source 12 can be a media program, an audio file, a movie and a picture, and the display device 14 can be a television. The multimedia source 12 can transmit the multimedia data stored in the multimedia source 12 to the media adapter 10 in a wired or wireless manner. The media adapter 10 can be utilized for decoding the multimedia data transmitted from the plurality of multimedia sources to generate signals that are receivable by the display device 14. Next, the signals are transmitted to the display device 14 in a wired or wireless manner so that the user can listen and watch the multimedia data on the display device 14.

More specifically, for example, the multimedia source 12 can be an Internet node. A file of the multimedia source 12 (i.e., originating from the multimedia source 12) which is downloaded from the Internet may have sexual or violence content which is unsuitable for general viewing, specifically, exposure to sexual and violent content transmitted from the multimedia sources through the media adapter 10 is often considered to be inappropriate for a young child or teenager. There is no restriction mechanism that exists in the present media adapter 10. Thus this represents a significant disadvantage.

### SUMMARY OF THE INVENTION

The claimed invention discloses a method for utilizing a media adapter for controlling a display device to display information of multimedia data corresponding to user access informationuser access information. The method comprises the following steps: inputting the user access informationuser access information to the media adapter; a plurality of multimedia sources respectively transmitting to the media adapter category information of multimedia data stored in the plurality of multimedia sources; the media adapter classifying the multimedia data transmitted from the plurality of multimedia sources according to the category information of the multimedia data received in the above step; comparing a classification result of the above step with the user access information; the media adapter outputting to the display device data corresponding to a comparison result of the above step; and the display device displaying a frame corresponding to the comparison result.

The claimed invention further discloses a media adapter capable of controlling a display device to display information of multimedia data corresponding to user access information. The media adapter comprises: an input interface, a receiving module, a decoding module, an output module, and a control module. The input interface accepts the user access information; the receiving module receives multimedia data and the category information of the multimedia data transmitted from a plurality of multimedia sources; the decoding module decodes data received by the receiving module to generate signals receivable by the display device; the output module outputs the signals generated by the decoding module to the display device; and the control module classifies the multimedia data transmitted from the plurality of multimedia sources according to the category information of the multimedia data received by the receiving module, for comparing a classification result with the user access information, and for controlling the output module to output the signals generated by the decoding module to the display device according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a conventional media adapter converting multimedia data of a plurality of multimedia sources to a display device.

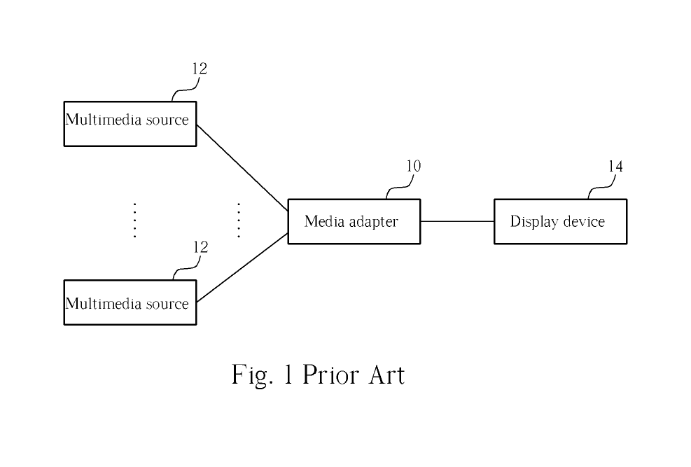

FIG. 2 illustrates a functional block diagram of a media adapter converting multimedia data stored in a plurality of multimedia sources to a display device according to the present invention.

FIG. 3 illustrates a flowchart of utilizing a media adapter for controlling a display device to display a data list of multimedia data stored in a plurality of multimedia sources according to the present invention.

FIG. 4 illustrates a diagram of file information of multimedia data of a multimedia source according to the present invention.

### DETAILED DESCRIPTION

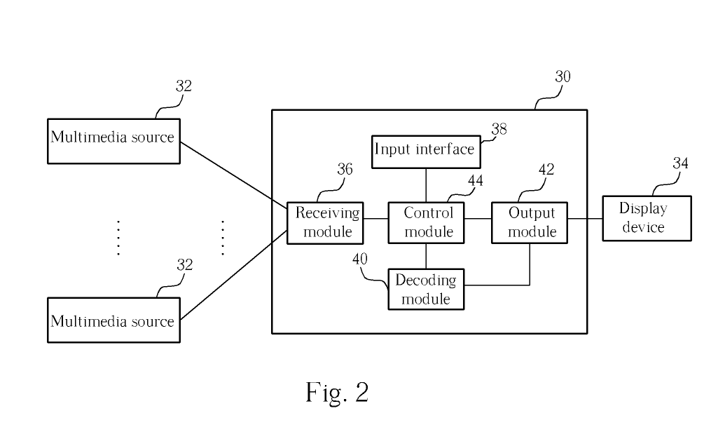

Please refer to FIG. 2. FIG. 2 illustrates a functional block diagram of a media adapter 30 converting multimedia data stored in a plurality of multimedia sources 32 to a display device 34 according to the present invention. The multimedia source 32 can be, for example, a computer, a hard disk, a media server, or a DVD player. The multimedia data stored in the multimedia source 32 can be, for example, a media program, an audio file, a movie, or a picture. Finally, the display device 14 can be, for example, a television. The media adapter 30 includes a receiving module 36 for receiving category information of multimedia data and the multimedia data transmitted from the plurality of multimedia sources 32, where the receiving module 36 can receive the data transmitted from the plurality of multimedia sources 32 in a wired or wireless manner. The media adapter 30 further includes an input interface 38 for a user to input a user access information, or for a user to set the category information of the multimedia data stored in the plurality of multimedia sources; additionally, the input interface 38 can be utilized by the user to select the category information of the multimedia data of the plurality of the multimedia sources 32 to be transmitted to the multimedia source 32 of the display device 34. The input interface 38 can be an on screen display (OSD). The media adapter 30 further includes a decoding module 40, an output module 42, and a control module 44. The decoding module 40 is for decoding the multimedia data received by the receiving module 36 to generate signals receivable by the display device 34. The output module 42 is coupled to the decoding module 40 and is for outputting the signals generated by the decoding module 40 to the display device 34. The control module 44 is coupled to the receiving module 36, the input interface 38, the decoding module 40, and the output module 42 and is for classifying the multimedia data of the plurality of multimedia sources 32 according to the category information of the multimedia data received by the receiving module 36. The output module 42 is also for comparing the classification result with the user access information received by the input interface 38. Finally, the control module 42 is also for controlling the output module 42 to output the signals generated by the decoding module 40 to the display device 34. Please note that the control module 44 can be presented in a software or hardware method. The multimedia data source 32 can transmit the multimedia data stored in the multimedia source 36 of the media adapter 30 in a wired or wireless manner. The decoding module 40 of the media adapter 30 can be utilized for decoding the multimedia data transmitted from the plurality of multimedia sources 32 to generate signals receivable by the display device 34, and for utilizing the output module 42 to transmit the signals to the display device 34 in a wired or wireless manner so that the user can listen and watch multimedia data on the display device 34.

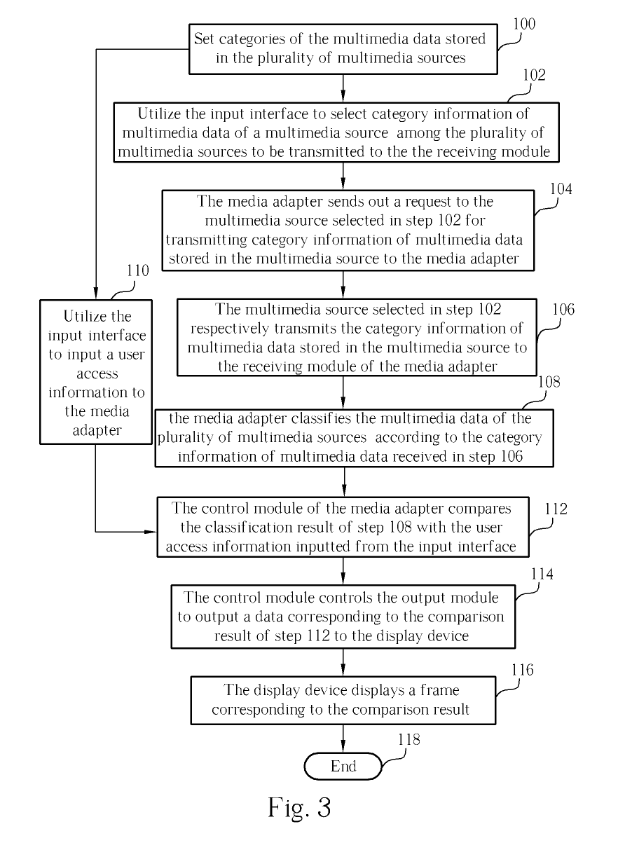

Please refer to FIG. 3. FIG. 3 illustrates a flowchart of utilizing a media adapter 30 for controlling a display device 34 to display a data list of multimedia data stored in a plurality of multimedia sources 32. The method includes the following steps:

Step 100: set categories of the multimedia data stored in the plurality of multimedia sources 32;

Step 102: utilize the input interface 38 to select category information of multimedia data of a multimedia source 32 among the plurality of multimedia sources 32 to be transmitted to the receiving module 36;

Step 104: the media adapter 30 sends out a request to the multimedia source 32 selected in step 102 for respectively transmitting category information of multimedia data stored in the multimedia source 32 to the media adapter 30;

Step 106: the multimedia source 32 selected in step 102 respectively transmits the category information of multimedia data stored in the multimedia source 32 to the receiving module 36 of the media adapter 30;

Step 108: the media adapter 30 classifies the multimedia data of the plurality of multimedia sources 32 according to the category information of multimedia data received in step 106;

Step 110: utilize the input interface 38 to input a user access information to the media adapter 30;

Step 112: the control module 44 of the media adapter 30 compares the classification result of step 108 with the user access information inputted from the input interface 38;

Step 114: the control module 44 controls the output module 42 to output a data corresponding to the comparison result of step 112 to the display device 34;

Step 116: the display device 34 displays a frame corresponding to the comparison result;

Step 118: end.

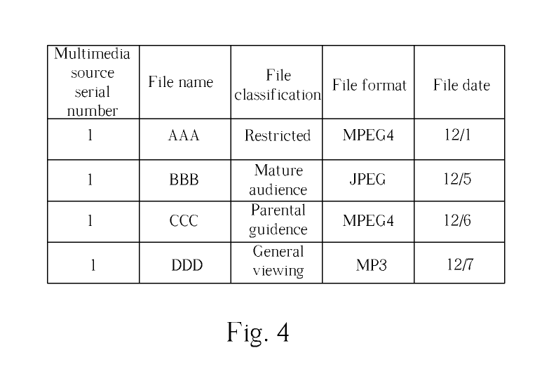

The following is provided to further explain the above-mentioned steps. First, a user, for example, sets the categories of the multimedia data stored in the plurality of multimedia sources 32, wherein the setting method can be achieved by directly setting the categories of the multimedia data stored in the multimedia source 32 at the multimedia source 32 end, or by setting the categories of the multimedia data stored in the plurality of multimedia sources 32 through the input interface 38 of the media adapter 30, where the categories of the multimedia data can be set to provide a classification of the multimedia data. For example, please refer to FIG. 4 for further illustration. FIG. 4 illustrates a diagram of file information of multimedia data of a multimedia source 32. The file information includes a serial number of the multimedia source 32, a file name of the multimedia data, a file classification of the multimedia data, a file format of the multimedia data, and a file date of the multimedia data. Please note that a different multimedia source 32 will generate different specific file information of the multimedia data. Additionally, file classification of the multimedia data includes categories such as, for example: restricted, mature audience, parental guidance, and general viewing. The classification of the multimedia data can be set according to or similar to the TV parental guidelines system of United States. In other words, the multimedia data having been classified with the general viewing category can be viewed by general audience, the parental guidance category is associated with a program not suitable for young children, the mature audience category is associated with a program that is not intended for and should not be viewed by audiences under the age of 17, and finally, the restricted category is associated with a program that can only be viewed by audiences above the age of 18. However, the United States' TV parental guidelines system is provided by way of example and not limitation. Classification data of the multimedia data can be set according to the user's requirement in the same way as previously described, and hence the details of this will not be reiterated.

Next, the user can utilize the input interface 38 to select the category information of the multimedia data of the multimedia source among the plurality of multimedia source 32 to be transmitted to the receiving module 36. In other words, the user can select category information of the multimedia data of a multimedia source 32, a plurality of multimedia sources 32, or even all of the multimedia sources 32 to be transmitted to the receiving module 36. Next, the media adapter 30 will send out a request to the multimedia sources 32 selected by the user for respectively transmitting the category information of the multimedia data stored in the multimedia sources 32 to the media adapter 30. Next, the control module 44 of the media adapter 30 will then classify the multimedia media of the plurality of multimedia sources 32 according to the category information of multimedia data received by the receiving module 36. For example, the previously mentioned categories, such as: restricted, mature audience, parental guidance, and general viewing. At the same time, the user can utilize the input interface 38 to input a user access information to the media adapter 30, where the user access information includes a user name and a password. Next, the control module 44 of the media adapter 30 will compare the classification result with the user access information inputted from the input interface 38. Each set of user access information can correspond to a file classification of a certain level, thus, the control module 44 can compare and seek the classification result that is compliant with the multimedia data of the file classification of the user access information. Next, the output module 42 is controlled to output to the display device 34 a data list of the multimedia data compliant with the file classification of the user access information so that the display device 34 displays a frame corresponding to the comparison result. In other words, the user can view the data list of the multimedia data that is compliant with the file classification of the user access information inputted by way of the input interface 38 through the frame.

For example, as illustrated in FIG. 4, if a set of user access information corresponds to a file classification restriction, then when the user access information is utilized to login to the media adapter 30, the user can directly view a data list of the multimedia data corresponding to the file classification of categories such as restricted, mature audience, parental guidance, and general viewing (data list of file names AAA, BBB, CCC, DDD, etc.). Similarly, if a set of user access information corresponds to a file classification of a mature audience category, then when the user access information is utilized to login to the media adapter 30, the user can directly view a data list of the multimedia data corresponding to the file classification of categories such as mature audience, parental guidance, and general viewing (data list of file names BBB, CCC, DDD), hence the user cannot view the data list of the multimedia data corresponding to the file classification of the restriction category (data list of file AAA). Furthermore, if a set of user access information corresponds to the file classification of the parental guidance category, then when the user access information is utilized to login to the media adapter 30, the user can directly view the data list of the multimedia data corresponding to the file classification of categories such as parental guidance and general viewing (data list of file names CCC, DDD), hence the user cannot view the data list of the multimedia data corresponding to the file classification of the categories such as restriction and mature audience (data list of file names AAA, BBB). Lastly, if a set of user access information corresponds to the file classification of the general viewing category, then when the user access information is utilized to login to the media adapter 30, the user can directly view the data list of the multimedia data corresponding to the file classification of category such as general viewing (data list of file name DDD), hence the user cannot view the data list of the multimedia data corresponding to the file classification of the categories such as restriction, mature audience and parental guidance (data list of file names AAA, BBB, CCC). Furthermore, a set of user access information can be set to correspond to file classification of an administrator, in another words, when the user access information is utilized to login to the media adapter 30, the user can directly login to administrate the multimedia data stored in each multimedia source 32, for example, setting the category (file classification) of the multimedia data stored in each multimedia source 32.

Also, a hot key can be installed on the input interface 38. The hot key can be used when the user does not wish to stay logged in to the media adapter 30 after inputting the user access information through the input interface 38. For example, the user can press the hot key to log out from the media adapter 30. Thereafter, when a next user utilizes the media adapter 30, the next user is again required to input the user access information through the input interface 38 similar to what the previous user did. It is also possible to configure the media adapter 30 to automatic log out any user that is logged in after a predetermined time period has passed since a previous operation. It is also possible to configure the media adapter 30 to automatic log out any user that is logged in when the media adapter is turned off. As a result, the user access information has to be inputted again through the input interface 38 when the media adapter is later turned on.

In comparison to the conventional method in utilizing a media adapter for controlling a display device to display a data list of multimedia data stored in a multimedia source and related media adapter, the method of the present invention utilizes a media adapter for receiving category information of multimedia data transmitted from a plurality of multimedia sources, and thereafter the media adapter of the present invention classifies the multimedia data transmitted from the plurality of multimedia sources according to the category information of the multimedia data received. The present invention media adapter controls the display device to display a data list of the multimedia data stored in the plurality of multimedia sources according to the classification result and a comparison result of a user access information received by the media adapter. In conclusion, the present invention can effectively perform classification of the multimedia data received from the plurality of multimedia sources to assist parents in restricting and filtering the multimedia data that is unsuitable for young children or teenagers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for utilizing a media adapter for controlling a display device to display information of multimedia data corresponding to user access information, the method comprising following steps:
(a) inputting the user access information to the media adapter;
(b) a plurality of multimedia sources respectively transmitting category information of multimedia data stored in the plurality of multimedia sources to the media adapter;
(c) the media adapter classifying the multimedia data transmitted from the plurality of multimedia sources according to the category information of the multimedia data received in step (b);
(d) comparing a classification result of step (c) with the user access information;
(e) the media adapter outputting data corresponding to a comparison result of step (d) to the display device; and
(f) the display device displaying a frame corresponding to the comparison result.

2. The method of claim 1 further comprising:
(g) setting the categories of the multimedia data stored in the plurality of multimedia sources.

3. The method of claim 2 wherein step (g) comprises setting the categories of the multimedia data stored in the plurality of multimedia sources through the plurality of multimedia sources.

4. The method of claim 2 wherein step (g) comprises setting the categories of the multimedia data stored in the plurality of multimedia sources through the media adapter.

5. The method of claim 2 wherein step (g) comprises setting classifications of the multimedia data stored in the plurality of multimedia sources.

6. The method of claim 5 wherein step (d) comprises comparing a classification result of step (g) with the user access information.

7. The method of claim 1 further comprising selecting a multimedia source from the plurality of multimedia sources to transmit multimedia data to the display device.

8. A media adapter capable of controlling a display device to display information of multimedia data corresponding to user access information, the media adapter comprising:
an input interface for inputting the user access information;
a receiving module for receiving multimedia data and category information of the multimedia data transmitted from a plurality of multimedia sources;
a decoding module for decoding data received by the receiving module to generate signals receivable by the display device;
an output module for outputting the signals generated by the decoding module to the display device; and
a control module for classifying the multimedia data transmitted from the plurality of multimedia sources according to the category information of the multimedia data received by the receiving module, for comparing a classification result with the user access information, and for controlling the output module to output signals generated by the decoding module to the display device according to the comparison result.

9. The media adapter of claim 8 wherein the input interface is an on screen display (OSD).

10. The media adapter of claim 8 wherein the input interface is further utilized for setting the category information of the multimedia data stored in the plurality of multimedia sources.

11. The media adapter of claim 8 wherein the input interface is further utilized for setting classifications of the multimedia data stored in the plurality of multimedia sources.

12. The media adapter of claim 10 wherein the control module is capable of comparing the classifications of the multimedia data with the user access information.

13. The media adapter of claim 8 wherein the input interface is further utilized for selecting a multimedia source from the plurality of multimedia sources to transmit multimedia data to the display device.

14. The media adapter of claim 13 wherein the selected multimedia source is a computer.

15. The media adapter of claim 13 wherein the selected multimedia source is a DVD player.
